(19) United States
(12) Patent Application Publication
(10) Pub. No.: US 2009/0157605 A1
(43) Pub. Date: Jun. 18, 2009

(54) METHOD AND APPARATUS FOR MANAGING FILES

(75) Inventor: Declan Patrick Kelly, Shanghai (CN)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/719,548

(22) PCT Filed: Nov. 15, 2005
(86) PCT No.: PCT/IB05/53751

§ 371 Date: May 17, 2007

(30) Foreign Application Priority Data
Nov. 23, 2004 (CN) 200410097807.8

(51) Int. Cl. G06F 17/30

(52) U.S. Cl. 707/3; 707/100; 707/E17.044; 707/E17.014

(57) ABSTRACT

This invention relates to a method and apparatus for managing files, in particular to a method and apparatus for managing file by using metadata. The invention provides a method of estimating the user's possible interest level in a file, and comprises the steps of: monitoring the user's actions on the file; obtaining the user's possible interest level according to the user's actions; and associating the possible interest level with the file in the form of metadata. According to the metadata, the user could quickly search for the file.

### FIELD OF INVENTION

This invention relates to a method for managing files, in particular to a method and apparatus that manages the files by using metadata.

### BACKGROUND OF THE INVENTION

With the development of modern technology, people could obtain a lot of information at any time, so the number of files that people have increases rapidly. For instance, with the popularization of digital camera and digital video camera, users will have more and more private files like digital photos and video segments which record travel experiences, ceremonies and the course of growing up of children, etc. With the progress of time, the number of files increases continuously, so in face of files of such a great number, it becomes a very big challenge for the user to effectively manage and quickly look up them.

In the prior art file management technology, metadata is generally used for files management. Metadata is data about data used for describing information about the files. Metadata could provide standard, general description method and identification tool for files in various forms. The purposes of using metadata to manage files are that:

(1) discovery and identification for helping people to discover and identify desired files; this metadata is usually used to note information like the author, title, subject, position, etc., and Dublin Core is the typical representative;

(2) cataloging for cataloging the files comprehensively and in detail; this metadata includes information of content, carrier, position and obtaining manner, making and using method, etc., and representatives of such kind of metadata are machine readable catalogue (MARC), Government Information Locator Service (GILS) and Federal geographic Data Committee/Content Standard for Digital Geospatial Metadata (FGDC/CSDGM);

(3) resource administration for managing the storing and using of files; this metadata includes information about Rights/Privacy Management and the like;

(4) preservation and archiving for preserving and archiving file; this metadata usually also includes contents of detailed format information, making information, protection condition, migration methods in addition to describing and identifying files.

However, the current metadata used for files management describes the objective information about the files themselves, but it cannot reflect the subjective information of the user to the file, so it usually takes a lot of time and efforts to manage and searching for the files.

Therefore, there is the need for a method for estimating the user's interest level on the files so as to obtain metadata that reflects the user's subject opinions on the contents of file and to facilitate the user to effectively manage and quickly search for the files.

### OBJECT AND SUMMARY OF INVENTION

One of the objects of the present invention is to provide a method for estimating the user's possible interest level in a file, comprising the steps of monitoring the actions that the user takes on the file; obtaining the user's possible interest level in the file based on the user's actions; and associating the possible interest level with the file in the form of metadata. Furthermore, the method also comprises the step of adjusting the possible interest level based on the relevant information of the contents of file, such as the time of taking photos, the place of taking photos, people concerned and the definition thereof.

According to the present invention, the step of obtaining the user's possible interest level in the file includes: obtaining the current value of the possible interest level; updating the current value based on the user's actions. By means of this method, the user's actions on the file could be tracked and thereby to dynamically obtain the user's possible interest level in the file.

Another object of this invention is to provide a file recommendation method, comprising the steps of monitoring the user's actions on the file; obtaining the user's possible interest level in the file according to the user's actions; associating the possible interest level with the file in the form of metadata; and recommending the file to the user according to the metadata and the request from the user.

In the present invention, if the user's action is sharing the file with a particular user, then the file recommendation method will further includes the step of associating information of the particular user with the file in the form of metadata.

In the present invention, if the user's action is continuously browsing the file and another particular file, then the file recommendation method will further includes the step of associating information of the particular file with the file in the form of metadata.

Another object of the present invention is to provide an estimation apparatus for estimating the user's possible interest level in a file, comprising monitoring means for monitoring the user's actions on the file; obtaining means for obtaining the user's possible interest level in the file based on the user's actions; and association means for associating the possible interest level with the file in the form of metadata.

Another object of the present invention is to provide a file playing device comprising storing means for storing a file on a storage medium; an estimation apparatus for estimating the user's possible interest level in the file; retrieving means for retrieving the file from the storage medium according to the possible interest level; and playing means for playing the file. Wherein the estimation apparatus comprises monitoring means for monitoring the user's actions on the file; obtaining means for obtaining the user's possible interest level in the file based on the user's actions; and association means for associating the possible interest level with the file in the form of metadata.

Another object of the present invention is to provide a computer program product for estimating a user's possible interest level in a file. The computer program comprises: code for monitoring the user's actions on the file; code for obtaining the user's possible interest level in the file based on the user's actions; and code for associating the possible interest level with the file in the form of metadata.

### BRIEF DESCRIPTION OF THE DRAWINGS

By means of demonstrative embodiments and the attached figures, the present invention and the corresponding advantages will be further illustrated. In the figures:

FIG. 1 shows the flowchart of a file recommendation method according to the present invention;

FIG. 2 schematically shows components of an estimation apparatus according to the present invention;

FIG. 3 schematically shows components of a file playing device according to the present invention.

In all the figures, the same reference numerals represent the similar or same features and functions.

### DETAILED DESCRIPTION OF THE INVENTION

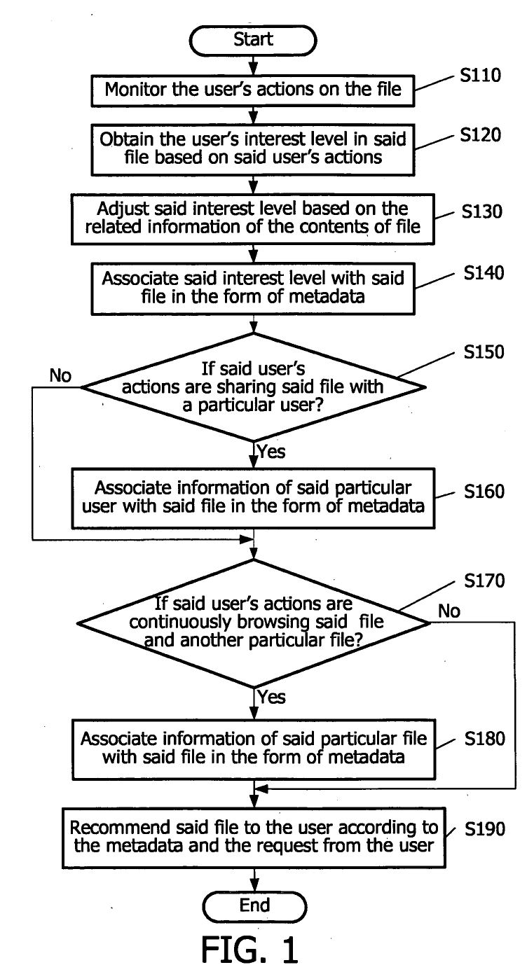

FIG. 1 shows the flowchart of a file recommendation method according to the present invention.

In the present embodiment, it is supposed that the user has a great number of digital photos. The present invention provides a method that estimates the user's possible interest level in the digital photos based on the user's actions on the digital photos and recommends the digital photos to the user according to the possible interest level.

The “possible interest level” herein does not means that the interest level is in an uncertain state, but it is that the interest level may not absolutely precisely reflect the user's real objective interest level, so the wording “possible interest level” is used.

Firstly, the user's actions on a file are monitored (step S110).

The user's actions on the digital photos refer to the use of the digital photos by the user. For example, the user browses the digital photos, prints the digital photos, edits and processes the digital photos, uploads the digital photos to a particular website and sends the digital photos to a particular person, etc.

When the user opens the digital photos to browse, the time in which the user browses the digital photos will be monitored. Similarly, when the user prints the digital photos, the action of printing the digital photos by the user could be monitored, including the number of photos printed and the number of printing. In addition, when the user edits the digital photos, i.e., adding special effects to the photos, making slides, modifying red eyes, cutting and rotating, etc., the time that the user takes in editing the digital photos and the times that the user edits the photos will be monitored. Likewise, the actions that the user uploads the digital photos to a particular website and sends the digital photos to a particular person could be monitored.

Secondly, the user's possible interest level in the file is obtained according to the user's actions (step S120).

By analyzing the user's actions on the digital photos, it could be seen that the actions on the digital photos reflect the user's possible interest level in the digital photos. For example, the user will usually take more time in seeing the digital photos that he likes or even browses them again and again. Therefore, the longer the time taken by the user to browse the digital photos each time is, the higher the user's possible interest in the digital photos is. Likewise, if the user particularly chooses one of the digital photos to print, it indicates that the user is very satisfactory with the digital photo and is willing to print it to enjoy. Hence, the action that the user prints the digital photo indicates that the user has greater interest in the digital photo. Similarly, the action of editing the digital photo by the user, the action of uploading the digital photo to a particular website and the action of sending the digital photo to a particular person (such as father or mother) also indicate that the user has greater interest level in the digital photo. Therefore, analyzing the user's actions could obtain the user's possible interest level in the digital photo.

The method of obtaining the user's possible interest level in the digital photo comprises:

1. Obtaining the current value of the possible interest level.

The user's possible interest level in a digital photo could be represented by a value. The current value of the possible interest level reflects the user's possible interest level in the digital photo at present. It may either be the default value of the user's possible interest level in a digital photo, or be the available value of the user's possible interest level in the digital photo. The default value of possible interest level could be set by the manufacturer of the digital camera, or it may also be an initial value set by the user himself. The current value of the user's possible interest level in the digital photos could be input manually.

2. Updating the current value based on the user's actions on the digital photo.

In the present embodiment, the current value of the possible interest level is updated according to the time taken by the user to browse the digital photos each time. The user's browsing time is calculated according to the time taken by the user to browse the digital photos each time, accordingly, the user's possible interest level in the digital photos is continuously updated according to each browse made by the user.

Suppose that the user's possible interest level in the digital photos is a value among 0-100, and the default value of the possible interest level in the digital photos set by the manufacturer of digital camera is 50; and in case there is a sudden change in the user's interest level in the digital photos caused by some accidental reasons, it could be supposed that the maximum value added to the interest level by the user's browse of the digital photos each time is 20. Meanwhile, the standard time for the user to browse the digital photos is set to be 20 seconds, when the time taken by the user to browse the digital photos is 1 second more than the standard time, the value of the user's interest level in the digital photos will be added by 1, otherwise, when the time taken by the user to browse the digital photos is 1 second less than the standard time, the value of the user's interest level in the digital photos will subtract 1. Likewise, in case the metadata that reflects the fondness of the user to the digital photos changes suddenly due to the user's quick browse, the influence of action of browsing for less than 5 seconds to the value that reflects the user's interest level in the digital photos will not be taken into account.

The user browses the digital photos four times, and the time of the first browsing, the second browsing, the third browsing and the fourth browsing are respectively 25 second, 60 seconds, 15 seconds and 3 seconds.

When browsing for the first time, the user's possible interest level in the digital photo is updated to 50+(25-20)=55.

When browsing for the second time, the browsing time is 60 seconds. Although the browsing time exceeds the standard time of 40 seconds, since the maximum value added to interest level by the user's browse of the digital photos each time is 20, the user's possible interest level in the digital photo is updated to 55+20=75.

When browsing for the third time, the user's possible interest level in the digital photo is updated to 75+(15-20)=70.

When browsing for the fourth time, the browsing time is 3 seconds. Since the browsing time is less than 5 seconds, the browsing does not influence the value that reflects the user's interest level in the digital photos, and the user's possible interest level in the digital photo is still 70.

If the user selects the digital photos to print, the value that reflects the user's possible interest level in the digital photos will be further added by 5, then the value of possible interest level will be 70+5=75.

Of course, the user's possible interest level in the digital photos could be updated according to the total time for the user to browse the digital photos. For example, when the total time taken by the user to browse the digital photos increases 10 seconds, the value of the user's possible interest level in the digital photos will be added by 1. Likewise, the user's possible interest level in the digital photos could be updated according to the times that the user browses the digital photos. For example, when the user browses the digital photos once more, the value of the user's possible interest level in the digital photos will be added by 1. In the above two cases, the value of the user's possible interest level in the digital photos increases every time.

The value representing the user's possible interest level in the digital photos could also be adjusted by the user manually. Since the user's manual adjustment will more objectively reflect the user's possible interest level in the digital photos, the user's manual adjustment mode could be set as preference mode.

It is obvious that the greater the user's fondness to the digital photos is, the greater the user's possible interest level in the digital photos is.

Thirdly, the possible interest level is adjusted according to the relevant information of the contents of file (step S130).

Relevant information of the contents of file refers to the objective information that describes the contents of the file. In the present embodiment, the relevant information of digital photos includes the time of taking the digital photo, the place of taking the digital photo, the people concerned in the digital photo and the definition of the digital photo, etc. The relevant information of digital photos reflects the user's possible interest level in the digital photos to some extent. Therefore, the user's possible interest level in the digital photos could be adjusted according to the relevant information.

When the date of taking the digital photos satisfies the calendar preset by the user, it usually indicates that the user has particular interest level in the digital photos. For example, the digital photos taken on the user's birthday have special meanings to the user, so the user's interest level in the digital photos taken on that day is greater than the interest level in digital photos taken at other times. If the user's birthday is Oct. 1, 1980, a calendar of October 1 of every year will be preset. When the date of taking the digital photos is the user's birthday in each year, the value of the user's possible interest level in the digital photos will be added by 5.

When the place of taking the digital photos satisfies the place preset by the user, it also indicates that the user has particular interest level in the digital photos. Since the digital photos taken at the place that is closely associated with the user have special meanings to the user, the user's interest level in the digital photos taken at that place is greater than the interest level in digital photos taken at other places. Digital camera having the function of global positioning (GPS) could position the place of taking the digital photo, such as Ricoh digital camera RDC-i700G. If the user's home is set as a preset location, when the location of taking the digital photo determined by the digital camera having the function of global positioning (GPS) is the user's home, the value of the user's possible interest level in the digital photos will be added by 5.

When the digital photos include particular persons, it also indicates that the user has particular interest level in the digital photos. The particular persons in the digital photos could be recognized by means of image recognition technology. If the digital photos include particular persons, such as the user's son, the value of the user's possible interest level in the digital photos will be added by 5.

When the definition of the digital photos reaches the preset definition, it also indicates that the user has particular interest level in the digital photos. Digital photos of high definition have better visual effects than the ones of low definition, so if the user chooses higher resolution to take a digital photo, it indicates that the user has greater interest level in the digital photo. If the resolution of the digital camera is set to be 300 dpi*300 dpi (dpi: dot per inch), then when the resolution of the digital photo is higher than or equal to the value, the value of the user's possible interest level in the digital photos will be added by 5.

The value of the user's possible interest level in the digital photos could be adjusted personally according to the user's setting of the relevant information of the digital photos, so that the user's interest level in the digital photos could flexibly reflect the user's possible interest in the digital photos.

Fourthly, the interest level is associated with the file in the form of metadata (step S140).

The interest level obtained according to the above method could either be stored as a part of the file in the form of metadata or be stored in a separate database.

For example, in the exchangeable image file format for digital still cameras: Exif Version 2.2) made by JEITA (Japan Electronics & Information Technology Industries. Association), the user's interest level in digital photos could be stored in the exchangeable image file in the form of metadata. Specifically, it could be stored in the area of user comment (eucm-ck) in the data description of image file specification. Wherein, exchangeable image file (Exif) is one of the Joint Photographic Experts Group (JEPG) standard for recording the action parameters when the digital camera is taking photos. Such file format is mainly used in the field of digital camera, and index table and contents on the information of taking photos could be added in the head of the JEPG file.

A central database also could be used to store the Interest Level for all stored pictures. This database could be very simple and include, for each picture, the current Interest Level and the file name. For example:

| Interest Level | Filename |
|---|---|
| 70 | DSC1001.jpg |
| 50 | DSC1002.jpg |
| . . . | . . . |
| 85 | Birthday1.jpg |
| . . . | . . . |

Storing the meta-data in a central database has the advantage that it is quicker to search, when the meta-data is stored in individual files, each file needs to be opened to read the meta-data, which makes searching slower. The disadvantage of the database is that it needs to be kept up-to-date as files are added and deleted.

Meanwhile, the time, the place of taking the digital photo, people concerned in the digital photo and the definition of the digital photo could be manually input to the digital photo file in the form of metadata or be input to a particular file which is associated with the digital photo.

Fifthly, it is to be determined whether the user's action is sharing the file with a particular user (step S150).

The user will usually send the digital photos or video segments that he is interested in to his family or friends to share, so it is to be determined if the user's action is sharing the file with a particular user, such as his wife. The user may share the digital photos with the particular user by E-mail, point-to-point communication network or website address, and in these ways, the digital photos or video segments could be sent to the particular user.

Sixthly, information of the particular user is associated with the file in the form of metadata (step S160).

If the user's action is sharing the digital photos with a particular user, information of the particular user will be associated with the digital photos in the form of metadata. Information of the particular user could be the name of the particular user, such as the name of his wife. Thus the metadata reflecting that the digital photos are shared with the particular user is generated, and all the digital photos sent to the particular user or the digital photos sent to the particular user in the latest three months could be quickly searched for in the future according to the metadata.

Seventhly, it is to be determined whether the user's action is continuously browsing the file and another particular file (step S170).

The user's operation on the file is analyzed. If the user browses another file right after browsing one file, then it indicates that the two files have certain association. Another particular file may be another digital photo or a segment of video.

Eighthly, information of the particular file is associated with the file in the form of metadata (step S180).

If the user's action is continuously browsing digital photos and another particular file, information of the particular file will be associated with the file in the form of metadata. Thus when the user opens the digital photos, according to the changed metadata, the particular file will be automatically recommended to the user in a certain manner, and this greatly facilitates the user's search for particular file associated with the digital photos.

Finally, the file is recommended to the user according to the metadata and a request from the user (step S190).

A request from the user may includes conditions of the user's interest level in the digital photos, and by recommending digital photos satisfying conditions of the interest level to the user, he is helped in searching for digital photos that he is interested in.

The user has 2000 digital photos, and suppose a request from the user is recommending digital photos whose interest level is more than 75, then according to the user's interest level and request, 20 digital photos are recommended to the user. Thus the user's search for the digital photos is greatly facilitated.

If a request from the user is recommending digital photos whose interest level is more than 75 and which have been sent to the user's mother, then according to the user's interest level and the information of particular user, 5 digital photos whose interest level is more than 75 and whose information of particular user is the user's mother are searched for among all the digital photos, so the 5 digital photos are recommended to the user. In this way, the user could quickly find the digital photos that he wants to look for.

These digital photos could also be sorted according to the user's interest levels in them, thereby the time taken by the user to search for his favorite digital photos is greatly reduced and the efficiency of searching is greatly improved.

This invention could also be applied in video segments. Likewise, the user's actions on the video segment are monitored and the user's interest level in the video segment is obtained according to the user's actions on the video segment. When the user is watching the video segment, he will watch the contents he likes in normal speed or even repeatedly play them, while the contents he dislikes will be played in fast speed so as to skip them quickly. Therefore, by analyzing the playing time of the video segment of a particular time period, the user's interest level in the video segment of a particular time period could be estimated.

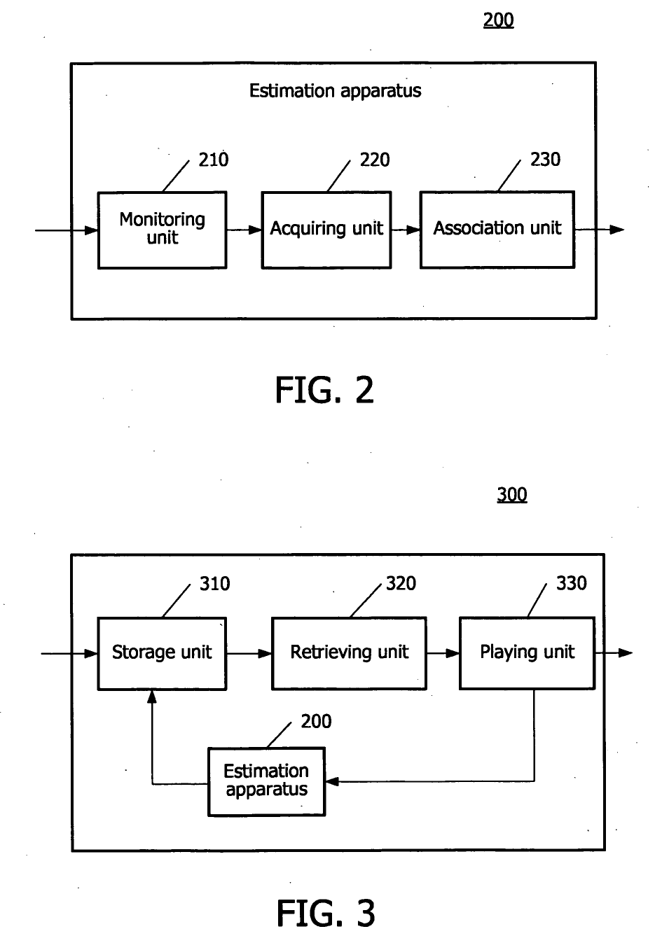

FIG. 2 schematically shows components of an estimation apparatus according to the present invention. The estimation means is used for estimating the user's possible interest level in a file, comprising a monitoring unit 210 for monitoring the user's actions on the file; an obtaining unit 220 for obtaining the user's possible interest level in the file according to the user's actions; an association unit 230 for associating the possible interest level with the file in the form of metadata.

A monitoring unit 210 is used for monitoring the user's actions on the file. One example is that when the user opens the digital photos to browse, the monitoring unit 210 monitors the time in which the user browses the digital photos or the times. Similarly, the monitoring unit 210 could also used for monitoring the user's actions of printing the digital photos, editing and processing the digital photos, uploading the digital photos to a particular website and sending the digital photos to a particular persons, etc.

Of course, monitoring unit 210 could also records the monitored actions for future use. For example, the user's time for browsing, the times of browsing, the number of photos printed and time for editing as recorded by the monitoring unit 210 every time could be accumulated, so that the obtaining unit 220 could obtain the user's possible interest level in the file based on the user's total time for browsing, the total times of browsing, the total number of photos printed and the total time for editing.

An obtaining unit 220 is used for obtaining the user's possible interest level in the file according the user's actions. Specifically, the obtaining unit could be arranged to obtain the current value of the possible interest level, and then update the current value according to the user's actions on the digital photos as monitored by the monitoring unit 210. The current value of the possible interest level includes the default value of the user's possible interest level in the digital photos or the available value of the user's possible interest level in the digital photos. After obtaining the current value, the obtaining unit 220 will obtain the user's possible interest level based on the user's actions on the digital photos, and these actions may include the time for browsing the file, the action of printing the digital photos, the action of editing the digital photos by the user, the action of uploading the digital photos to a particular website or the action of sending the digital photos to a particular person (such as the user's father).

An association unit 230 is used for associating the possible interest level with the file in the form of metadata. The possible interest level obtained by the obtaining unit 220 is stored as a part of the file in the form of metadata through the association unit 230, or it could also be stored in a separate database. Establishing association between the file and the user's possible interest level in the file through the association unit 230, so that the user could effectively manage the file by means of the metadata of the possible interest level in the file.

The present invention could also be implemented by appropriately programmed computer, which is provided with a computer program product for estimating a user's possible interest level in a file. The computer program includes a code for monitoring the user's actions on the file; a code for obtaining the user's possible interest level in the file according to the user's actions; and a code for associating the possible interest level with the file in the form of metadata.

The program codes could be supplied to the processor to form a machine, so that the codes executed on the processor generate unit that implements the above-mentioned function.

FIG. 3 schematically shows components of a file playing device according to the present invention. Another object of the present invention is to provide a file playing device, comprising a storage unit 310 for storing a file on a storage medium; an estimation apparatus 200 for estimating the user's possible interest level in the file; a retrieving unit 320 for retrieving the file from the storage medium according to the possible interest level; and a playing unit 330 for playing the file. Wherein, the estimation apparatus 200 comprises a monitoring unit 210 for monitoring the user's actions on the file; an obtaining unit 220 for obtaining the user's possible interest level in the file according to the user's actions; and an association unit 230 for associating the possible interest level with the file in the form of metadata.

A storage unit 310 is used for storing a file on a storage medium. Storage unit 310 could also be used for storing metadata in a certain form. The storage medium could be hard drive or any other suitable mediums such as CD-RW. The estimation unit 200 is used for estimating the user's possible interest level based on the user's actions on the file stored in the storage unit 310 and for associating the possible interest level with the file in the form of metadata. The retrieving unit 320 could be arranged to retrieve the file from the storage unit 310 according to a condition including the possible interest level. The file retrieved by the retrieving unit 320 is played on the playing unit 330.

Meanwhile, according to the user's actions (such as time) of browsing the file when the file is being played on the playing unit 330, the estimation apparatus 200 could re-estimate the user's possible interest level in the file. Thus the user could select the file to be played according to the possible interest level, meanwhile, the user's possible interest level in the file could be updated according to the playing of the file, thereby presenting an interactive amusing experience to the user.

While the invention has been described in conjunction with specific embodiments, it is evident that many alternatives, modifications and variations will be apparent to those skilled in the art in light of the foregoing description. Accordingly, it is intended to embrace all such alternatives, modifications and variations as fell within the spirit and scope of the appended claims.

1. A method of estimating a user's possible interest level in a file, comprising the steps of:
a. monitoring the user's actions on the file;
b. obtaining the user's possible interest level in the file according to the user's actions;
c. associating the possible interest level with the file in the form of metadata.

2. The method according to claim 1, wherein the user's actions include at least one of the followings: browsing, printing, editing, uploading and sending.

3. The method according to claim 1, further comprising adjusting the possible interest level according to the relevant information of the contents of the file.

4. The method according to claim 3, wherein the file is a digital photo.

5. The method according to claim 3, wherein the file is a segment of digital video.

6. The method according to claim 4, the relevant information includes at least one of the following: time of taking photos, place of taking photos, people concerned and definition.

7. The method according to claim 1, wherein step (b) comprises:
(i) obtaining the available value of the possible interest level;
(ii) updating the available value according to the user's actions.

8. The method according to claim 1, wherein step (c) comprises storing the metadata in a database associated with the file.

9. A method of recommending a file, comprising the steps of:
a. monitoring a user's actions on the file;
b. obtaining the user's possible interest level in the file according to the user's actions;
c. associating the possible interest level with the file in the form of metadata;
d. recommending the file to the user according to the metadata and a request from the user.

10. The method according to claim 9, wherein the user's action is sharing the file with a particular user, further comprising the step of associating information of the particular user with the file in the form of metadata.

11. The method according to claim 9, wherein the user's action is continuously browsing the file and another particular file, further comprising the step of associating information of the particular file with the file in the form of metadata.

12. An estimation apparatus for estimating a user's possible interest level in a file, comprising
a. monitoring means for monitoring the user's actions on the file;
b. obtaining means for obtaining the user's possible interest level in the file according to the user's actions;
c. association means for associating the possible interest level with the file in the form of metadata.

13. A file playing device, comprising:
storage means for storing a file on a storage medium;
estimation means according to claim 12 for estimating the user's possible interest level in the file;
retrieving means for retrieving the file from the storage medium according to the possible interest level; and
playing means for playing the file.

14. A computer program product for estimating a user's possible interest level in a file, the computer program comprises:
(1) code for monitoring the user's actions on the file;
(2) code for obtaining the user's possible interest level in the file according to the user's actions;
(3) code for associating the possible interest level with the file in the form of metadata.

15. A storage carrier comprising the computer program product as claimed in claim 14.
